(19) United States
(12) Patent Application Publication
(10) Pub. No.: US 2022/0290949 A1
(43) Pub. Date: Sep. 15, 2022

(54) HIT-DETECTING, MOBILE-TARGET TRAINING SYSTEM

(71) Applicant: SimIS, Inc., Portsmouth, VA (US)

(72) Inventors: Johnny Garcia, Suffolk, VA (US); Max C. Luu, Beaverton, OR (US); Javaud A. Ahangari, Chesapeake, VA (US); Casey H. Batten, Virginia Beach, VA (US); Yiannis E. Papelis, Norfolk, VA (US)

(21) Appl. No.: 17/378,825

(22) Filed: Jul. 19, 2021

Related U.S. Application Data
(60) Provisional application No. 63/207,608, filed on Mar. 10, 2021.
(60) Provisional application No. 63/207,609, filed on Mar. 10, 2021.
(60) Provisional application No. 63/207,957, filed on Apr. 1, 2021.

(51) Int. Cl. F41J 5/04; F41J 5/14; F41J 9/02; G05D 1/00

(52) U.S. Cl. CPC F41J 5/042; F41J 5/14; F41J 9/02; G05D 1/0011

(57) ABSTRACT

A mobile-target training system includes a base having independently-controlled motorized wheels coupled thereto. A target is coupled to the base and has a penetration detector coupled thereto. The penetration detector includes an open electric circuit having electrical properties. The open electric circuit exhibits a change in its electrical properties for each occurrence of an object passing through the open electric circuit. A feedback generator coupled to the penetration detector generates recognizable feedback for each occurrence of change in the electrical properties of the open electric circuit.

Pursuant to 35 U.S.C. § 119, the benefit of priority from provisional applications 63/207,608 and 63/207,609, both with a filing date of Mar. 10, 2021, and provisional application 63/207,957, with a filing date of Apr. 1, 2021, are claimed for this non-provisional application.

### FIELD OF THE INVENTION

The invention relates generally to mobile-target training systems, and more particularly to a mobile-target training system that detects projectile hits of significance.

### BACKGROUND OF THE INVENTION

Today's military and security forces must be prepared to operate in dynamic and ever-changing operational environments that can be populated by a combination of threat entities, friendly entities, and neutral entities. In general, military/security forces must be proficient at acquiring entities, discerning their danger status, assessing risk and potential collateral damage to personnel and property, and then appropriately engaging the various types of entities in an operational area. In terms of threat entities, engagement often means shooting at the entity. Given the variety of potential operational scenarios and entities that can be encountered, military/security forces must be able to train with inanimate mobile entities/targets that replicate dynamic operational environments and scenarios.

Ideally, effective training programs would utilize inanimate and mobile targets capable of the following:
dynamic changes in direction of movement, speed of advance, and target posture;
unpredictability in terms of target movement, massing, and/or scattering in direction and/or rate of advance;
presenting complex operational scenarios involving multiple different types of targets (e.g., threat, friendly, and neutral) concurrently and confounding predictability of location of the real threat to the military or security force;
presenting ambiguous scenarios to train for misreads between threat entities versus those that are friendly or neutral, and misreads related to threat force massing or movements; and
presenting unambiguous feedback regarding target “hits” during shooting exercises.

Previous target training systems include those using fixed-location targets (e.g., staked and/or pop-up targets), rail-mounted targets capable of movement along fixed-position rails or tracks, and individually mobile or robotic units. Fixed-location targets and rail-mounted targets are limited in value since they are incapable of addressing the requirements of an effective training program as outlined above. Further, fixed-location targets have a large operational footprint, are a logistics support challenge, and present intensive maintenance requirements due to their constant exposure to the elements. Existing mobile/robotic units are capable of less restricted movement in an operational environment, but generally use a variety of leader-follower schemes that lack unpredictability and the ability to present complex operational scenarios. Further, existing mobile/robotic units can present ambiguous target “hit” results owing to their use of inertial impact sensors for registering a target “hit”. Unfortunately, ricochets, shrapnel, and other irrelevant impact events generated in direct fire engagement of targets are frequently recognized and recorded as “hits” by impact sensors on other/nearby mobile target systems thereby skewing the engagement results and value of training exercises.

### SUMMARY OF THE INVENTION

Accordingly, it is an object of the present invention to provide a hit-detecting, mobile-target training system.

Another object of the present invention is to provide a mobile-target training system that records target “hits” in a way that unambiguously indicates when a direct hit on a mobile target by a shooter has occurred.

Still another object of the present invention is to provide a mobile-target training system that can control multiple mobile targets simultaneously in a semi-autonomous fashion.

Yet another object of the present invention is to provide a mobile-target training system having mobile targets that adapt to changing environmental surface conditions to maintain a prescribed target-track direction and speed.

Other objects and advantages of the present invention will become more obvious hereinafter in the specification and drawings.

In accordance with the present invention, a mobile-target training system includes a base and a plurality of independently-controlled motorized wheels coupled to the base. A target is coupled to the base and has a penetration detector coupled thereto. The penetration detector includes an open electric circuit having electrical properties. The open electric circuit exhibits a change in its electrical properties for each occurrence of an object passing through the open electric circuit. A feedback generator is coupled to the penetration detector for generating at least one of a visual feedback and an audible feedback for each occurrence of change in the electrical properties of the open electric circuit.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a schematic front plan view of a hit-detecting, mobile-target training system in accordance with an embodiment of the present invention;

FIG. 2 is a schematic top plan view of the training system's motorized wheels and wheel control system in accordance with an embodiment of the present invention;

FIG. 3A is an isolated schematic view of the training system's penetration detecting circuit in its open-circuit state prior to penetration by a bullet;

FIG. 3B is an isolated schematic view of the training system's penetration detecting circuit as it is being penetrated by a bullet;

FIG. 3C is an isolated schematic view of the training system's penetration detecting circuit again in its open-circuit state after being penetrated by a bullet;

FIG. 4 is a schematic view of a penetration detecting circuit in its unpenetrated, open-circuit state in accordance with an embodiment of the present invention;

FIG. 5 is a schematic view of the penetration detecting circuit of FIG. 4 in its penetrated state as a bullet is illustrated in the process of passing through the circuit to affect the electrical properties thereof in accordance with an embodiment of the present invention;

FIG. 6 is a schematic view of a hit-detecting, mobile-target training system illustrating a feedback generator in accordance with an embodiment of the present invention;

FIG. 7 is a schematic view of a hit-detecting, mobile-target training system to include a remote control in accordance with another embodiment of the present invention;

FIG. 8A is an isolated perspective view of a three-dimensional human-like target having multiple penetration detectors mounted thereon and illustrated in a pre-hit orientation in accordance with an embodiment of the present invention;

FIG. 8B is an isolated perspective view of the human-like target having multiple penetration detectors mounted thereon and illustrated in a non-lethal “hit” orientation in accordance with an embodiment of the present invention; and

FIG. 8C is an isolated perspective view of the human-like target having multiple penetration detectors mounted thereon and illustrated in a lethal “hit” orientation in accordance with an embodiment of the present invention.

### DETAILED DESCRIPTION OF THE INVENTION

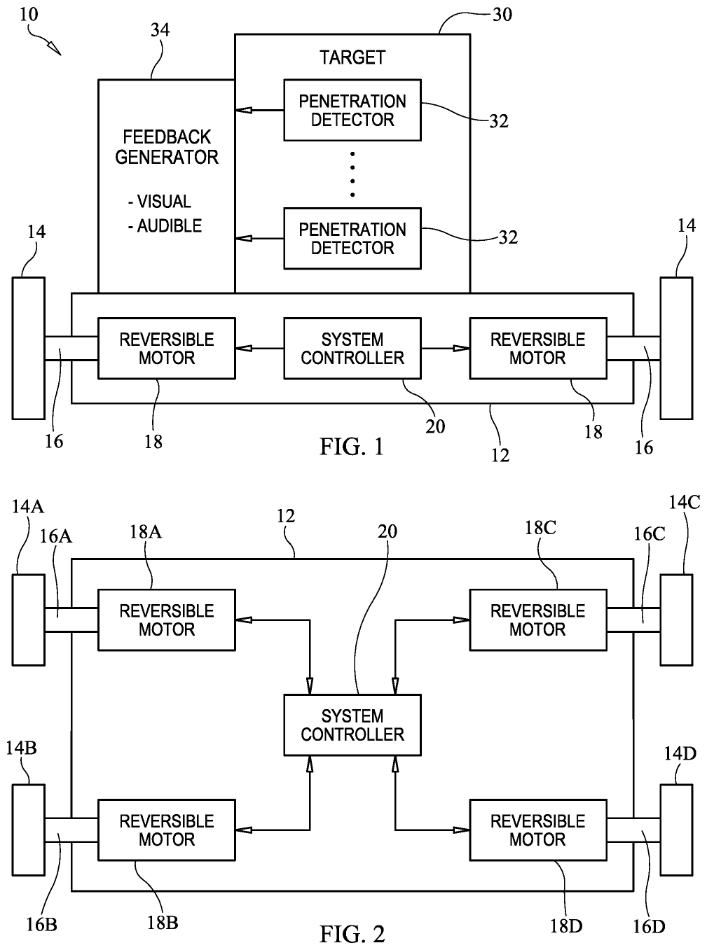

Referring now to the drawings and more particularly to FIG. 1, a schematic view of a hit-detecting mobile-target training system in accordance with an embodiment of the present invention is shown and is referenced generally by numeral 10. Briefly, system 10 is a mobile unit designed to travel over a ground surface environment in accordance with a control scheme, while providing unambiguous feedback to only indicate a “hit” when a target portion of system 10 is penetrated by a shooter's bullet traveling along its original aimed path. One or more of system 10 can be used in a training scenario as will be described further below.

System 10 includes a base 12 supported by a number of wheels 14 that engage a ground surface (not shown). Each of wheels 14 is rotated forward or backward on its corresponding axle 16 that is driven by a dedicated reversible motor 18. Motors 18 are powered and controlled independently by instructions from a system controller 20. Each of motors 18 can include an onboard motor controller (not shown) for implementing the instructions received from system controller 20. In some embodiments of the present invention, system controller 20 can be programmed with a path/speed plan governing rotation direction and rotation speed of each of wheels 14 to thereby dictate precise movements of system 10 over a ground surface. In other embodiments of the present invention, system controller 20 is provided with waypoint navigation data or manual control data over a wireless communications link as will be described later herein.

System 10 also includes a target 30 coupled to base 12 such that target 30 moves with base 12. Target 30 has one or more penetration detectors 32 coupled thereto. Briefly, each penetration detector 32 is an electrical circuit having electrical properties that undergo a change only when a bullet (not shown) on its original aimed path penetrates the detector. That is, each penetration detector's electrical properties are not changed by slower-paced impact events such as bullet ricochets, bullet shrapnel, and other impact events not associated with a bullet's original aimed path. Each time a bullet penetrates one of detectors 32 to cause a change in the detector's electrical properties, a “hit” signal indicative of such electrical property change is provided to a feedback generator 34. In response to receiving a “hit” signal, feedback generator 34 generates one or more of visual feedback and audible feedback that can be recognized by trainees and training personnel. Feedback generator 34 can include a dedicated processor governing its operations, or the processing aspects of feedback generator 34 could be provided by system controller 20 without departing form the scope of the present invention.

Referring additionally now to FIG. 2, a schematic plan view is shown of an exemplary motorized wheel and control system. In the illustrated embodiment, four wheels 14A-14D are used, with wheels 14A/14B being disposed on the left side of base 12 and wheels 14C/14D being disposed on the right side of base 12. Each of wheels 14A-14D is independently controlled/rotated forward or backward by the corresponding combination of motor and axle (e.g., motor 18A/axle 16A rotate wheel 14A, etc.). Control signals and power governing each motor's operation are provided by system controller 20. As mentioned above, a predetermined or manually-entered path directed and managed by system controller 20 provides the basis for the generation of control signals that cause the path to be traversed via independent control of wheels 14A-14D via respective ones of motors 18A-18D.

A variety of environmental surface obstacles (e.g., rocks, roots, holes, man-made trash, ground undulations, standing water, mud, ice, etc.) can cause system 10 to deviate from a desired path and/or speed of travel. To minimize the effects caused by ground surface obstacles, some embodiments of the present invention can employ a unique wheel control scheme to keep system 10 on its intended path and at its intended speed. Since each planned path dictates rotation speed and direction for each of wheels 14A-14D, system controller 20 can be programmed to continuously monitor differential torque between pairs of wheels 14A-14D, and compare the differential torque with what should be present for the execution of the planned path. When differences occur, system controller 20 directs and manages motors 18A-18B to modify the rotation speed/direction of the appropriate ones of wheels 14A-14D to minimize error between what the differential torque is and what is should be for each pair of wheels. For the illustrated four-wheel embodiment, differential torque for six pairs of wheels is monitored, i.e., 14A/14B, 14A/14C, 14A/14D, 14C/14D, 14B/14C and 14B/14D.

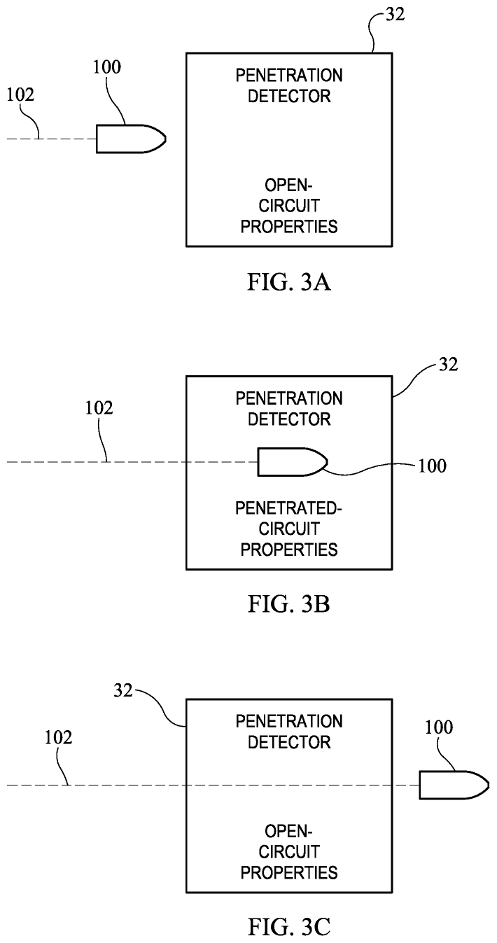

In general, each penetration detector's electrical circuit is an open circuit having electrical properties characterized by a zero voltage/current. When a bullet penetrates a detector's open electrical circuit, the electrical properties thereof are momentarily changed. A sequence of events associated with a bullet penetration of a penetration detector's open circuit is presented in FIGS. 3A-3C. Prior to being penetrated by a bullet 100 traveling along its original aimed path 102, a penetration detector 32 has open circuit properties as shown in FIG. 3A. When bullet 100 is in the process of penetrating detector 32 as shown in FIG. 3B, the detector's circuit briefly or momentarily exhibits penetrated circuit properties that are different from the detector's open circuit properties to thereby indicate a target “hit”. After bullet 100 has passed through detector 32 as shown in FIG. 3C, the detector's electrical circuit once again exhibits its pre “hit” open circuit properties such that penetration detector 32 is again ready to detect a “hit”.

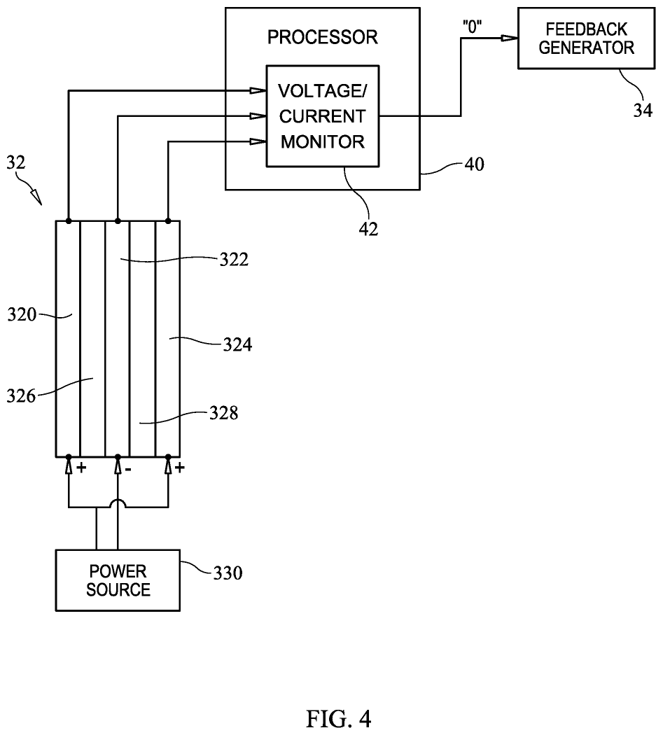

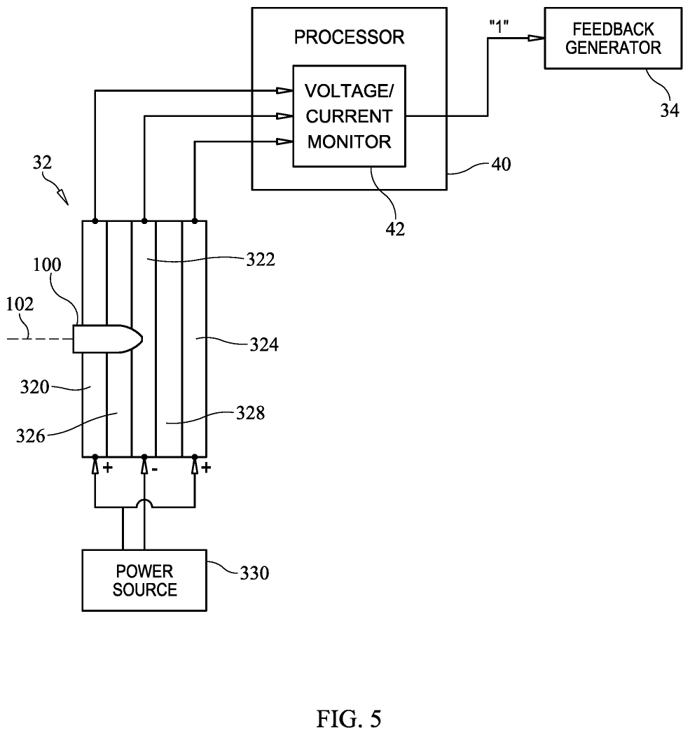

Some embodiments of the present invention can utilize a unique layered arrangement of electrically-conductive plates and electrical insulator material for a penetration detector's electrical circuit. By way of an illustrative example, one such layered electrical circuit of a penetration detector 32 is illustrated in its pre “hit” state in FIG. 4, and during a penetration thereof by a bullet 100 in FIG. 5. In the illustrated embodiment, the layered arrangement has three electrically-conductive plates 320/322/324 and two layers of electrical insulator material 326/328. More specifically, plates 320/322 are spaced apart from one another by insulator layer 326, and plates 322/324 are spaced apart from one another by insulator layer 328. Spacing between plates 320/322 and plates 322/324 is less than the length of a bullet expected to pass there through. It is to be understood that the present invention could be practiced with a layered arrangement using only two electrically-conductive plates or more than three such plates without departing from the scope of the present invention. As will be explained further below, the use of three electrically-conductive plates provides advantageous performance without excess cost associated with additional layers.

Plates 320/322/324 are electrically charged in accordance with an alternating polarity scheme between adjacent plates. In the illustrated embodiment, plates 320 and 324 are positively charged (“+”) and plate 322 is negatively charged (“−”). It is to be understood that the polarities on the plates could be reversed without departing from the scope of the present invention. Electric charging of the plates can be provided by a power source 330 coupled thereto. As a result of this structure, open electrical circuits are defined by plates 320/322 and plates 322/324. The above-described layered arrangement can be made from flexible materials and be less than one inch in thickness thereby allowing the layered arrangement to be sized/shaped for coupling to contoured, three-dimensional surfaces. The spacing between adjacent electrically-conductive plates is generally less than the length of any bullet that the system will be used with.

Prior to being penetrated by a bullet (FIG. 4), the electrical properties of the open circuits defined by the layered arrangement are monitored by a processor 40. More specifically, processor 40 incorporates a voltage/current monitor 42. When in the pre-penetration state, voltage/current monitor 42 will measure a zero voltage/current state for one circuit incorporating plates 320/322 and for the other circuit incorporating plates 322/324. When both circuits are open circuits to indicate a non “hit” state, processor 40 is programmed to output a logical “0” to feedback generator 34 that, in turn, is configured not to generate any visual or audible feedback when supplied with a logical “0”.

Referring now to FIG. 5 where a bullet 100 traveling along its original aimed path 102 penetrates the layered arrangement of penetration detector 32, the electrical properties of the layered arrangement undergo a brief and reversible change. For an electrically-conductive bullet 100, the bullet's passage will briefly or momentarily cause a closed electrical circuit condition as it simultaneously spans and makes contact with plates 320/322 (as shown), plates 322/324, or all of plates 320/322/324, depending on the length of bullet 100. The resulting and brief closed electric circuit condition(s) cause voltage/current monitor 42 to measure a momentary positive or negative voltage/current (i.e., a non-zero value). The detection of any momentary non-zero voltage/current causes a logical “1” to be provided to feedback generator 34 that, in turn, generates a visual and/or audible feedback to indicate that a “hit” has occurred. The use of three electrically conductive plates is advantageous because it is provides sensitivity to a “hit” caused by a bullet that initially engages plate 324 as opposed to plate 320 as illustrated. This allows the present invention's target to receive a “hit” originating from a shooter that is in front of, behind, or at an angle to the target. Accordingly, processor 40 implements a logical “OR” operation to assure registration of a bullet “hit” regardless of the incoming direction of the bullet. Once bullet 100 exits the layered arrangement, penetration detector 32 reverts back to its open circuit state illustrated in FIG. 4.

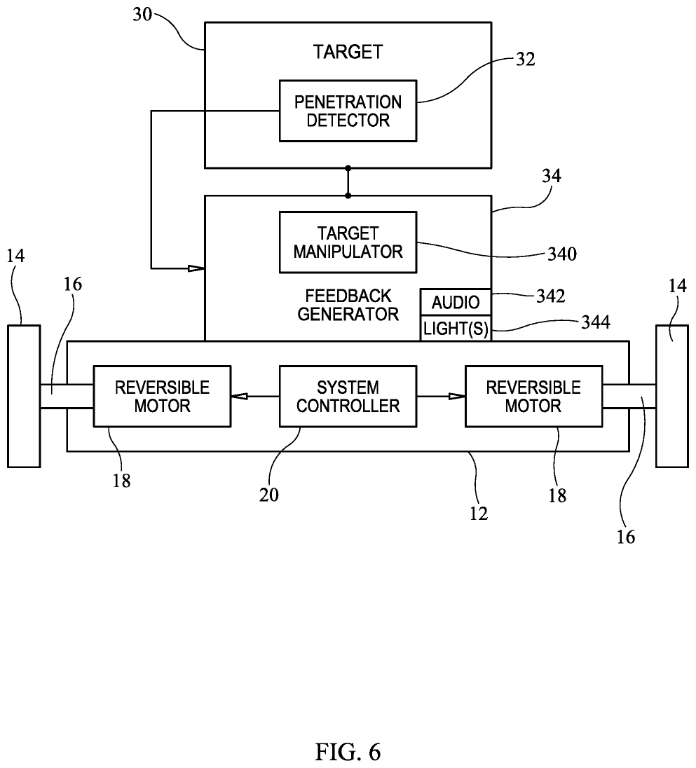

As mentioned above, the training system of the present invention provides one or more of visual feedback and audible feedback when a target “hit” is caused by a bullet passing through a penetration detector coupled to the system's target. The implementation of such feedback is carried out by the system's feedback generator. Referring now to FIG. 6, feedback generator 34 (coupled to base 12) can include a target manipulator 340 coupled to base 12 and target 30. When penetration detector 32 detects a “hit” as described above, feedback generator 34 activates manipulator 340 to reposition target 30 so that its new position presents a clear visual indication to the shooter and trainer that target 30 has been hit by a bullet. For example, manipulator 340 could reposition target 30 from a pre “hit” upright position to a post “hit” horizontal position. Simultaneous with the repositioning of target 30, feedback generator 34 could also activate an audio device 342 (e.g., to produce a scream noise) and/or light(s) 344 to provide audible feedback and an additional visual feedback, respectively.

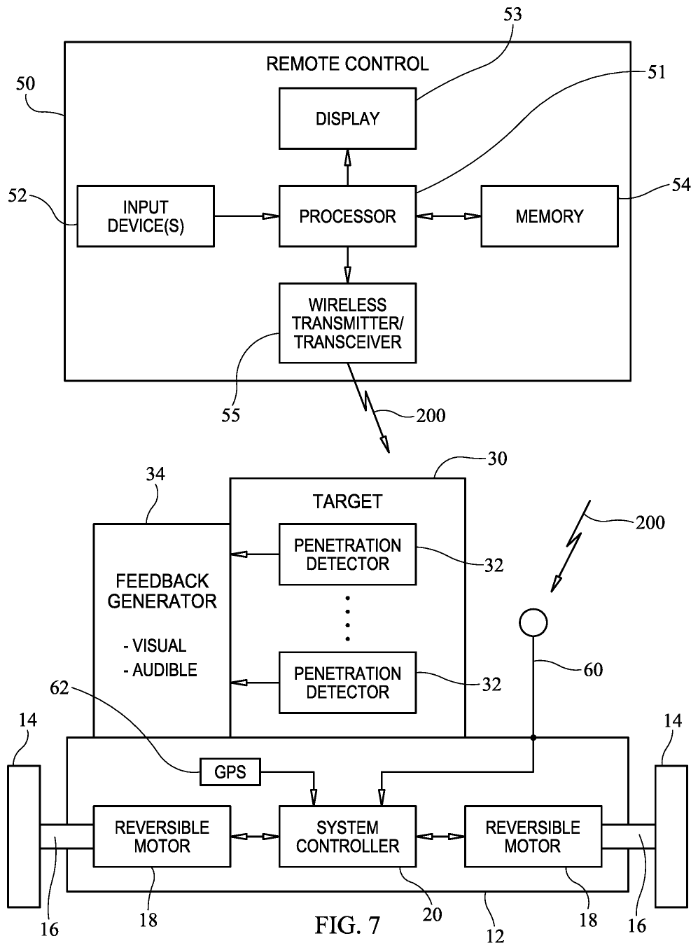

In some embodiments of the present invention, the above-described training system can further include a remote control for transmitting wireless control signals governing path traversal for one or more of the training system's mobile target units where each path is implemented by the respective mobile target unit's system controller 20 as described above. A system of the present invention that includes a remote control is illustrated in FIG. 7 where remote control 50 transmits wireless control signals 200 for receipt by an antenna 60 mounted on base 12 and coupled to system controller 20. System controller 20 also receives own location data from an onboard GPS receiver 62. At a minimum, remote control 50 includes an onboard processor 51, one or more input devices 52, a display 53, a memory 54, and a wireless transmitter/transceiver 55.

Processor 51 is programmed to carry out the various functions of remote control 50 which can include a unique communications scheme that will be described further below. Input devices 52 can include a keyboard and/or individual-function keys, voice recognition, port(s) for accepting external memory storage devices, etc. Display 53, memory 54, and transmitter/transceiver 55 can be any of a variety of known types of devices without departing from the scope of the present invention.

Ideally, training scenarios should present trainees with a number of moving targets traversing a ground environment along multiple and varied paths/speeds in order to replicate dynamic, unpredictable, and complex operational scenarios. In some embodiments of the present invention, these goals can be achieved using a single remote control 50 as will now be explained with reference to FIG. 7. Remote control 50 is capable of independent operational control of a plurality of the above-described mobile target units. The path to be traversed along with path speed for each mobile target unit can be input manually at remote control 50, could be selected from a number of routes stored on memory 54, could be input to memory 54 from an external storage device (not shown) coupled to remote control 50, or could be supplied wirelessly to remote control 50 for storage on memory 54 or immediate re-transmission via transmitter/transceiver 55. A route plan can be in the form of waypoint navigation data that identifies a plurality of waypoints along a planned route. The waypoint navigation data can be in the form of GPS coordinates that power/controller 20 uses in conjunction with its own GPS location data to control the mobile target unit's wheels. Power/controller 20 can also use the above-described differential torque between pairs of a mobile target unit's wheels to continuously update wheel control data to keep the associated mobile target unit on its planned route/speed.

For operational scenarios involving a plurality of mobile target units, remote control 50 can implement a unique communications scheme requiring no signal repeaters over communications distances of up to one mile, while also eliminating communication errors that can lead to errors in paths traversed by the mobile target units. To achieve a communications range of up to one mile, the communications scheme implemented by remote control 50 is carried out in the FCC-approved 900 MHz communications band. To assure error free transmission-receipt results, the present invention assigns a unique time window to each communications “node” in the operational scenario. For example, if four mobile target units were to be deployed and controlled by remote control 50, five nodes are defined. Thus, five time windows are used with one time window being assigned to remote control 50 and each of the other four time windows being assigned to a respective one of the mobile target units. The sequence of time windows is continuously repeated with each communications node being responsive only to signals/data appearing within its assigned time window.

The communications scheme can also employ Frequency Hopping Spread Spectrum (FHSS) technology and “packet” technology to improve the robustness of the wireless communications. Briefly, FHSS means that remote control 50 and each mobile target unit share a code indicating what frequency and when FHSS will “hop” randomly (e.g., approximately every 20 milliseconds) to randomly selected frequencies. The “packet” processing breaks a message into a series of packets where each packet has the following set of “tags”:
a tag identifying the packet's place in the flow (i.e., what packet precedes and what packet follows),
a tag identifying the size of data that the packet contains, and
a tag identifying the time that the packet is transmitted.
   The communications application assembles the packets in sequence, checks each to ensure it matches the time and size required, and then releases the message for transmission and implementation by system 10.

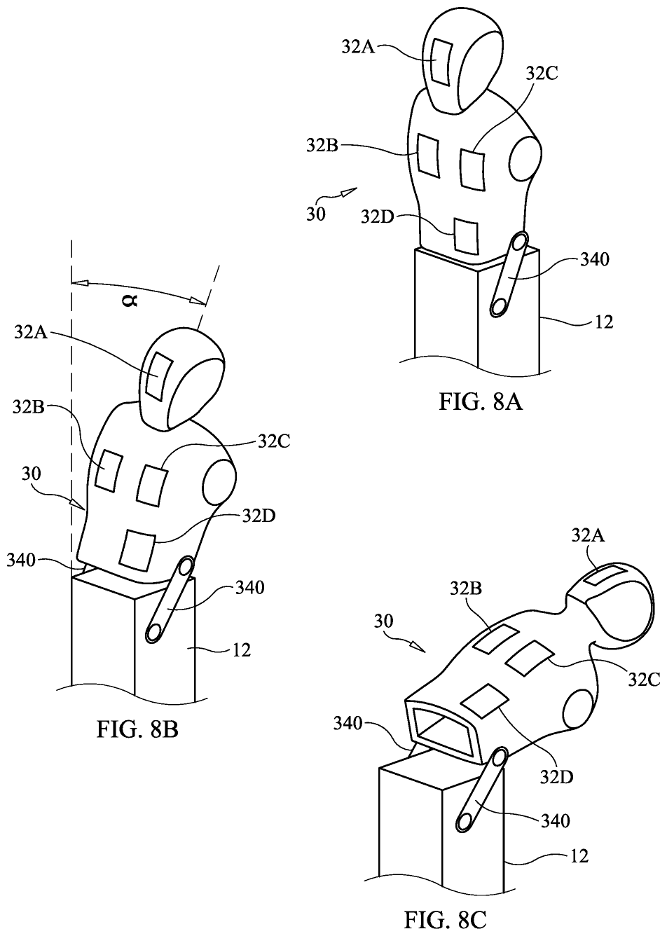

To further enhance the realistic training experience provided by the present invention, target 30 can be configured in three dimensions to resemble a human torso and head in both shape and size. In such embodiments, the target shape will necessarily have curved contours to present a realistic appearance. Accordingly, the above-described layered and flexible penetration detector (FIG. 4) is well-suited for coupling to such a target. By way of an illustrative example, each of FIGS. 8A-8C illustrates a three-dimensional human-like head/torso target 30 having multiple penetration detectors coupled thereto to provide lethal and non-lethal “hit” indications.

Target 30 is coupled to base 12 by target manipulator 340 (e.g., mechanized control arms as illustrated). In each of FIGS. 8A-8C, target 30 has four penetration detectors 32 coupled thereto. Detectors 32 can be placed on outside or inside surfaces of target 30 without departing from the scope of the present invention. In some embodiments of the present invention, the entire outer surface of target 30 comprises a puncture “self-healing” material (not shown). It is to be understood that the number, size, shape, and/or placement of detectors 32 can be different than that shown without departing from the scope of the present invention. In the illustrated embodiment, detector 32A is located at the target's head region, detector 32B is located at the target's right shoulder region, target 32C is located at the target's heart region, and target 32D is located at the lower right side of the target's abdomen region. For this arrangement of penetration detectors, a mobile target unit's feedback generator (not shown in FIGS. 8A-8C) can be programmed to recognize “hits” at detectors 32A and 32C as being lethal, while “hits” at detectors 32B and 32D are recognized as being non-lethal.

The present invention can utilize the concept of lethal and non-lethal indicating penetration detectors in the following manner. Prior to penetration of any of detectors 32A-32D, manipulator 340 positions target 30 in an upright (or standing) position as shown in FIG. 8A. A penetration of either detector 32B or 32D can be used to generate a non-lethal “hit” feedback response. For example, a non-lethal “hit” feedback response could be the manipulation or repositioning of target 30 by manipulator 340 to a position rotated backwards by an acute angle a (e.g., 15-30 degrees) from the FIG. 8A upright position to the position illustrated in FIG. 8B. In general, angle a should be selected such that the FIG. 8B position is distinguishable from the FIG. 8A and 8B positions. A penetration of either detector 32A or 32C can be used to generate a lethal “hit” feedback response. For example, a lethal feedback response could be the manipulation or repositioning of target 30 by manipulator 340 to a position rotated approximately 90° backward from the FIG. 8A upright position as illustrated in FIG. 8C. As mentioned above, the lethal feedback position of target 30 could be supplemented with audible feedback and/or additional visual feedback.

The advantages of the present invention are numerous. The hit-detecting mobile-target training system includes a mobile target unit that provides unambiguous indications of target “hits” caused by a bullet on its original aimed path. A remote control can be included with the system to provide for control of multiple mobile target units in accordance with a robust communications scheme requiring no signal repeaters even when relatively large training environments are utilized. Each mobile target unit can include a wheel control scheme that adapts to changing environmental surface conditions in order to keep the mobile target unit on its prescribed route.

Although the invention has been described relative to a specific embodiment thereof, there are numerous variations and modifications that will be readily apparent to those skilled in the art in light of the above teachings. For example, each mobile target unit of the present invention can be configured to transmit data (e.g., each lethal and/or non-lethal “hit”) back to the system's remote control where such data can be collected/stored for later evaluation. The target could also replicate the three-dimensional and contoured body (or body portions) of an animal (e.g., deer) such that the present invention can be incorporated into an entertainment venue for hunters. It is therefore to be understood that, within the scope of the appended claims, the invention may be practiced other than as specifically described.

What is claimed as new and desired to be secured by Letters Patent of the United States is:

1. A mobile-target training system, comprising:
a base;
a plurality of independently-controlled motorized wheels coupled to said base;
a target coupled to said base, said target having a penetration detector coupled thereto, said penetration detector including an open electric circuit having electrical properties, said open electric circuit adapted to exhibit a change in said electrical properties for each occurrence of an object passing through said open electric circuit; and
a feedback generator coupled to said penetration detector for generating at least one of a visual feedback and an audible feedback for each said occurrence of said change in said electrical properties.

2. A mobile-target training system as in claim 1, wherein said open electric circuit comprises:
a layered arrangement of electrically-conductive plates separated from one another by electrical insulator material; and
a power source coupled to said electrically-conductive plates for applying an electric charge to each of said electrically-conductive plates, said electric charge alternating in polarity between adjacent ones of said electrically-conductive plates wherein, for each said occurrence of an object passing through said open electric circuit, the object passes through said electrically-conductive plates to cause a momentary closed-circuit condition in said open electric circuit.

3. A mobile-target training system as in claim 2, wherein said arrangement comprises three of said electrically-conductive plates.

4. A mobile-target training system as in claim 1, wherein said feedback generator includes a manipulator coupled to said base and coupled to said target for altering a position of said target for each said occurrence of said change in said electrical properties.

5. A mobile-target training system as in claim 4, wherein said position of said target so-altered by said manipulator is predicated on a location of said penetration detector on said target.

6. A mobile-target training system as in claim 1, further comprising a system controller coupled to each of said motorized wheels, said system controller generating control signals for controlling each of said motorized wheels based on a differential torque between pairs of said motorized wheels.

7. A mobile-target training system as in claim 6, further comprising a remote control having a memory device for storing waypoint navigation data, said remote control wirelessly transmitting said waypoint navigation data to said system controller for use in generating said control signals.

8. A mobile-target training system as in claim 7, wherein said remote control includes an input device for receiving said waypoint navigation data to be stored by said remote control.

9. A mobile-target training system as in claim 7, wherein said remote control includes a communications controller for wirelessly transmitting said waypoint navigation data in a unique time window, and wherein said system controller is responsive only to said waypoint navigation data transmitted in said unique time window.

10. A mobile-target training system as in claim 9, wherein said communications controller is configured for wireless transmission in a 900 MHz communications band.

11. A mobile-target training system as in claim 1, wherein said target comprises a three-dimensional target configured to resemble a human head and torso.

12. A mobile-target training system as in claim 2, wherein said target comprises a three-dimensional shape having curved contours, and wherein said layered arrangement is flexible to mimic said curved contours when coupled to said target.

13. A mobile-target training system, comprising:
a base;
a plurality of independently-controlled motorized wheels coupled to said base;
a target coupled to said base, said target having at least one penetration detector coupled thereto, each said penetration detector including an open electric circuit having electrical properties, said open electric circuit adapted to exhibit a change in said electrical properties for each occurrence of an object passing through said open electric circuit, wherein said open electric circuit includes a layered arrangement of three electrically-conductive plates separated from one another by electrical insulator material, and wherein an electric charge is applied to each of said three electrically-conductive plates, said electric charge alternating in polarity between adjacent ones of said three electrically-conductive plates; and
a feedback generator coupled to said penetration detector for generating at least one of a visual feedback and an audible feedback for each said occurrence of said change in said electrical properties, said feedback generator including a manipulator coupled to said base and coupled to said target for altering a position of said target for each said occurrence of said change in said electrical properties,
wherein, for each said occurrence of an object passing through said open electric circuit, the object passes through said three electrically-conductive plates to cause a momentary closed-circuit condition in said open electric circuit.

14. A mobile-target training system as in claim 13, wherein said at least one penetration detector comprises a plurality of spaced-apart penetration detectors on said target and wherein, for each said occurrence of an object passing through said open electric circuit, said position of said target so-altered by said manipulator is predicated on a location of one of said penetration detectors associated with said occurrence.

15. A mobile-target training system as in claim 13, further comprising a system controller coupled to each of said motorized wheels, said system controller generating control signals for controlling each of said motorized wheels based on a differential torque between pairs of said motorized wheels.

16. A mobile-target training system as in claim 15, further comprising a remote control having a memory device for storing waypoint navigation data, said remote control wirelessly transmitting said waypoint navigation data to said system controller for use in generating said control signals.

17. A mobile-target training system as in claim 16, wherein said remote control includes an input device for receiving said waypoint navigation data to be stored by said remote control.

18. A mobile-target training system as in claim 16, wherein said remote control includes a communications controller for wirelessly transmitting said waypoint navigation data in a unique time window, and wherein said system controller is responsive only to said waypoint navigation data transmitted in said unique time window.

19. A mobile-target training system as in claim 18, wherein said communications controller is configured for wireless transmission in a 900 MHz communications band.

20. A mobile-target training system as in claim 13, wherein said target comprises a three-dimensional target configured to resemble a human head and torso.

21. A mobile-target training system as in claim 13, wherein said target comprises a three-dimensional shape having curved contours, and wherein said layered arrangement is flexible to mimic said curved contours when coupled to said target.

22. A mobile-target training system, comprising:
a base;
a plurality of independently-controlled motorized wheels coupled to said base;
a system controller coupled to each of said motorized wheels, said system controller generating control signals for controlling each of said motorized wheels based on a differential torque between pairs of said motorized wheels;
a target coupled to said base, said target having a penetration detector coupled thereto, said penetration detector including an open electric circuit having electrical properties, said open electric circuit adapted to exhibit a change in said electrical properties for each occurrence of an object passing through said open electric circuit; and
a manipulator coupled to said base and coupled to said penetration detector for altering a position of said target for each said occurrence of said change in said electrical properties.

23. A mobile-target training system as in claim 22, wherein said open electric circuit comprises a layered arrangement of electrically-conductive plates separated from one another by electrical insulator material, wherein an electric charge is applied to each of said electrically-conductive plates, said electric charge alternating in polarity between adjacent ones of said electrically-conductive plates wherein, for each said occurrence of an object passing through said open electric circuit, the object passes through said electrically-conductive plates to cause a momentary closed-circuit condition in said open electric circuit.

24. A mobile-target training system as in claim 23, wherein said arrangement comprises three of said electrically-conductive plates.

25. A mobile-target training system as in claim 22, wherein said position of said target so-altered by said manipulator is predicated on a location of said penetration detector on said target.

26. A mobile-target training system as in claim 22, further comprising a remote control having a memory device for storing waypoint navigation data, said remote control wirelessly transmitting said waypoint navigation data to said system controller for use in generating said control signals.

27. A mobile-target training system as in claim 26, wherein said remote control includes an input device for receiving said waypoint navigation data to be stored by said remote control.

28. A mobile-target training system as in claim 26, wherein said remote control includes a communications controller for wirelessly transmitting said waypoint navigation data in a unique time window, and wherein said system controller is responsive only to said waypoint navigation data transmitted in said unique time window.

29. A mobile-target training system as in claim 28, wherein said communications controller is configured for wireless transmission in a 900 MHz communications band.

30. A mobile-target training system as in claim 22, wherein said target comprises a three-dimensional target configured to resemble a human head and torso.

31. A mobile-target training system as in claim 23, wherein said target comprises a three-dimensional shape having curved contours, and wherein said layered arrangement is flexible to mimic said curved contours when coupled to said target.
